(19) United States
(12) Patent Application Publication
(10) Pub. No.: US 2024/0427991 A1
(43) Pub. Date: Dec. 26, 2024

(54) METHOD AND SYSTEM FOR TRAINING A NEURAL LANGUAGE-BASED MODEL FOR DATA ANNOTATION

(71) Applicant: JPMorgan Chase Bank, N.A., New York, NY (US)

(72) Inventor: Gauraw TRIPATHY, Hyderabad (IN)

(73) Assignee: JPMorgan Chase Bank, N.A., New York, NY (US)

(21) Appl. No.: 18/748,865

(22) Filed: Jun. 20, 2024

(30) Foreign Application Priority Data
Jun. 23, 2023 (IN) 202311041980

(51) Int. Cl. G06F 40/284

(52) U.S. Cl. CPC G06F 40/284

(57) ABSTRACT

A method and a system for training a neural language-based model for data annotation are disclosed. The method includes: receiving, via a communication interface, a set of data from a plurality of sources, each item of the set of data being associated with a pre-defined data class; generating at least one category vocabulary for the pre-defined data class; identifying at least one token in the set of data based on an analysis of the set of data, wherein the at least one token corresponds to a category indicator of the pre-defined data class; masking the at least one token; feeding the at least one masked token together with a corresponding contextual vector to the neural language-based model; and predicting, using the neural language-based model, a class of the at least one masked token using the corresponding contextual vector.

### CROSS-REFERENCE TO RELATED APPLICATIONS

This application claims priority benefit from Indian Application No. 202311041980, filed on Jun. 23, 2023 in the India Patent Office, which is hereby incorporated by reference in its entirety.

### FIELD OF THE DISCLOSURE

This technology generally relates to methods and systems for training a machine learning model, and more particularly to methods and systems for training a neural language-based model for automatic data annotation.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as an admission of the prior art.

As is generally known, there is an increasing demand for training data for machine learning. The demand has been further amplified with the fast adoption of machine learning technologies in various domains such as finance, banking, law, security, research, education, and the like. Conventionally, the process of generating training data involves human assistance in tasks such as labeling the classes in the data to generate training data.

The major problem with the conventional approaches/tools may include, but are not limited thereto, that the process of generating training data is highly dependent on human agency. The process involves expertise in labeling the raw data based on the classes of data present in the raw dataset. The problem is even more evident in situations where the unlabeled raw data is highly domain-specific, essentially meaning that the data classes in the unlabeled data are predetermined.

Hence, in view of these and other existing limitations, there arises an imperative need to provide an efficient solution to overcome the above-mentioned limitations and to provide a method and system for training a neural language-based model for data annotation.

### SUMMARY

The present disclosure, through one or more of its various aspects, embodiments, and/or specific features or sub-components, provides, inter alias, various systems, servers, devices, methods, media, programs, and platforms for training a neural language-based model for data annotation.

According to an aspect of the present disclosure, a method for training a neural language-based model for data annotation is disclosed. The method is implemented by at least one processor. The method includes receiving, by the at least one processor, a first set of data from a plurality of sources, each item of the first set of data being associated with a pre-defined data class. Next, the method includes generating, by the at least one processor, at least one category vocabulary for the pre-defined data class. Next, the method includes identifying, by the at least one processor, at least one token in the first set of data based on an analysis of the first set of data, wherein the at least one token corresponds to a category indicator of the pre-defined data class. Next, the method includes masking, by the at least one processor, the at least one token. Next, the method includes feeding, by the at least one processor, the masked at least one token together with a corresponding contextual vector to the neural language-based model. Thereafter, the method includes predicting, by the at least one processor using the neural language-based model, a class of the masked at least one token using the corresponding contextual vector.

In accordance with an exemplary embodiment, the identifying of the at least one token in the first set of data is performed by identifying, by the at least one processor, contextually similar words in the first set of data that represent the pre-defined data class; retrieving, by the at least one processor from a word repository, at least one replacement word for the contextually similar words; checking, by the at least one processor, an occurrence of the at least one replacement word in the at least one category vocabulary; and tagging, by the at least one processor, the contextually similar words as the at least one token in an event that the occurrence of the at least one replacement word in the at least one category vocabulary exceeds a threshold number.

In accordance with an exemplary embodiment, the method further includes implementing a self-training process for the neural language-based model on an unlabeled second set of data.

In accordance with an exemplary embodiment, the method further includes updating, by the at least one processor, the at least one category vocabulary with the identified at least one token for the pre-defined data class.

In accordance with an exemplary embodiment, the first set of data includes domain-specific data.

According to another aspect of the present disclosure, a computing device configured to implement an execution of a method for training a neural language-based model for data annotation is disclosed. The computing device includes a processor; a memory; and a communication interface coupled to each of the processor and the memory. The processor may be configured to receive, via a communication interface, a first set of data from a plurality of sources, each item of the first set of data being associated with a pre-defined data class. Next, the processor may be configured to generate at least one category vocabulary for the pre-defined data class. Next, the processor may be configured to identify at least one token in the first set of data based on an analysis of the first set of data, wherein the at least one token corresponds to a category indicator of the pre-defined data class. Next, the processor may be configured to mask the at least one token. Next, the processor may be configured to feed the masked at least one token together with a corresponding contextual vector to the neural language-based model. Thereafter, the processor may be configured to predict, using the neural language-based model, a class of the masked at least one token using the corresponding contextual vector.

In accordance with an exemplary embodiment, to identify the at least one token in the first set of data, the processor may be further configured to identify contextually similar words in the first set of data that represent the pre-defined data class; retrieve, from a word repository, at least one replacement word for the contextually similar words; check an occurrence of the at least one replacement word in the at least one category vocabulary; and tag the contextually similar words as the at least one token in an event that the occurrence of the at least one replacement word in the at least one category vocabulary exceeds a threshold number.

In accordance with an exemplary embodiment, the processor may be further configured to implement a self-training process for the neural language-based model on an unlabeled second set of data.

In accordance with an exemplary embodiment, the processor may be further configured to update the at least one category vocabulary with the identified at least one token for the pre-defined data class.

In accordance with an exemplary embodiment, the first set of data includes domain-specific data.

According to yet another aspect of the present disclosure, a non-transitory computer-readable storage medium storing instructions for training a neural language-based model for data annotation is disclosed. The instructions include executable code which, when executed by a processor, may cause the processor to receive, via a communication interface, a first set of data from a plurality of sources, each item of the first set of data being associated with a pre-defined data class; generate at least one category vocabulary for the pre-defined data class; identify at least one token in the first set of data based on an analysis of the first set of data, wherein the at least one token corresponds to a category indicator of the pre-defined data class; mask the at least one token; feed the masked at least one token together with a corresponding contextual vector to the neural language-based model; and predict, using the neural language-based model, a class of the masked at least one token using the corresponding contextual vector.

In accordance with an exemplary embodiment, to identify the at least one token in the first set of data, the executable code when executed further causes the processor to identify contextually similar words in the first set of data that represent the pre-defined data class; retrieve, from a word repository, at least one replacement word for the contextually similar words; check an occurrence of the at least one replacement word in the at least one category vocabulary; and tag the contextually similar words as the at least one token in an event that the occurrence of the at least one replacement word in the at least one category vocabulary exceeds a threshold number.

In accordance with an exemplary embodiment, the executable code when executed further causes the processor to implement a self-training process for the neural language-based model on an unlabeled second set of data.

In accordance with an exemplary embodiment, the executable code when executed further causes the processor to update the at least one category vocabulary with the identified at least one token for the corresponding pre-defined data class.

In accordance with an exemplary embodiment, the first set of data includes domain-specific data.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for training a neural language-based model for data annotation, in accordance with an exemplary embodiment.

FIG. 2 illustrates an exemplary diagram of a network environment for training a neural language-based model for data annotation, in accordance with an exemplary embodiment.

FIG. 3 illustrates a system diagram for training a neural language-based model for data annotation, in accordance with an exemplary embodiment.

FIG. 4 illustrates an exemplary method flow diagram for training a neural language-based model for data annotation, in accordance with an exemplary embodiment.

FIG. 5 illustrates a process flow diagram usable for training a neural language-based model for data annotation, in accordance with an exemplary embodiment.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skills in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Furthermore, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium, having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

To overcome the problems associated with the annotation of data on a large set of domain-specific data, the present disclosure provides a method and system for training a neural language-based model for automatic annotation of data. The system first receives a first set of data from a plurality of sources, each item of the first set of data being associated with a pre-defined data class. In an example, the first set of data comprises documents on advanced teaching methodologies, research papers on healthcare developments, and/or articles on trade arrangements between countries. Accordingly, each item of the first set of data has its predefined data class such as Educational, Economical, and Medical respectively. In an example, the plurality of sources may include social-based platforms, media-based platforms, publication of the official Gazette, and the like. Next, the system generates at least one category vocabulary for the pre-defined data class. In an example, the category vocabulary is generated by a pre-trained neural language-based model and includes words that are contextually similar to the pre-defined data class. Next, the system identifies at least one token in the set of data based on an analysis of the first set of data, wherein at least one token corresponds to a category indicator of the pre-defined data class. In an example, the neural language-based model identifies tokens in the set of data that may be a category indicative of the predefined data class. Next, the system masks the identified at least one token. Next, the system feeds the masked at least one token together with the corresponding contextual vector to the neural language-based model. In an example, the token is first retrieved based on the analysis of the first set of data, and then the corresponding contextual vector is provided to the neural language-based model with the masked token. Thereafter, the system predicts a class of the masked at least one token using the corresponding contextual vector. In an example, the neural language-based model predicts the data class corresponding to the masked at least one token using the contextual vector of the token.

In an example, the first set of data relates to the monetary policy of a government. The pre-defined data class in the set of data is also provided. In general, human expertise is relied upon to annotate the first set of data and to generate training data for machine learning models. However, this process is complex and requires expertise in identifying the pre-defined data class and tokens that are contextually similar to the pre-defined data class. Thus, the conventionally available solutions are complicated, and not reliable in terms of accuracy. Therefore, as per the solution of the present disclosure, the system is configured to automatically annotate the first set of data based on the corresponding pre-defined data class present in the first set of data using the trained neural language model.

Therefore, the present disclosure aids in annotating the first set of data with minimal human intervention. The automatic generation of training data using the neural language-based model thereby solves the problem of shortage of training data for machine learning models. The implementation of features of the present disclosure results in achieving better efficiency and performance owing to several factors. In an example, the factors include but are not limited to reducing dependency on human expertise, faster and reliable generation of training data, better prediction of pre-defined data classes present in the set of data, and better handling of the set of data, where the received set of data is highly domain-specific (e.g., the data classes are pre-defined).

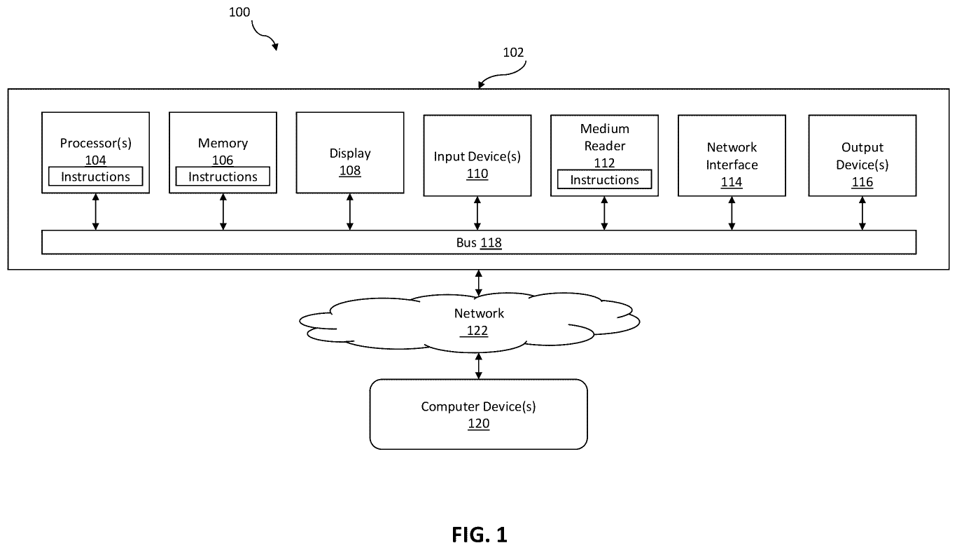

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As used herein, the token is the smallest unit of the first set of data that is relied upon by the neural language-based model in the process of performing data annotation on the first set of data.

As used herein, the contextual vector of a token corresponds to the contextual information associated with the token identified using the Natural Language Processing (NLP) based vectorization techniques.

As used herein, the category vocabulary includes the words that have contextually similar meanings to the pre-defined data class associated with the category vocabulary.

As illustrated in FIG. 1, the computer system 102 may include at least one processor 104. Processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. Processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a micro-controller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-control output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for training the neural language-based model for the data annotation.

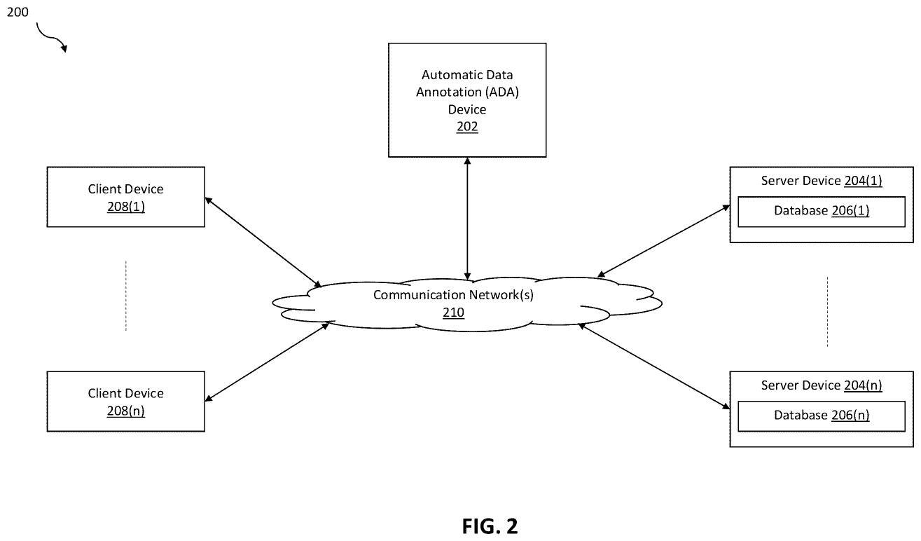

Referring to FIG. 2, a schematic of an exemplary network environment 200 for implementing a method for training the neural language-based model for the data annotation is illustrated. In an exemplary embodiment, the method is executable on any networked computer platform, such as, for example, a personal computer (PC).

The method for training the neural language-based model for the data annotation may be implemented by an automatic data annotation (ADA) device 202. The ADA device 202 may be the same or similar to the computer system 102 as described with respect to FIG. 1. The ADA device 202 may store one or more applications that can include executable instructions that, when executed by the ADA device 202, cause the ADA device 202 to perform desired actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

In a non-limiting embodiment, the application(s) may be operative in a cloud-based computing environment. The application(s) may be executed within or as a virtual machine(s) or virtual server(s) that may be managed in a cloud-based computing environment. Also, the application(s), and even the ADA device 202 itself, may be located in the virtual server(s) running in a cloud-based computing environment rather than being tied to one or more specific physical network computing devices. Also, the application(s) may be running in one or more virtual machines (VMs) executing on the ADA device 202. Additionally, in one or more embodiments of this technology, virtual machine(s) running on the ADA device 202 may be managed or supervised by a hypervisor.

In the network environment 200 of FIG. 2, the ADA device 202 is coupled to a plurality of server devices 204(1)-204(n) that hosts a plurality of databases 206(1)-206(n), and also to a plurality of client devices 208(1)-208(n) via communication network(s) 210. A communication interface of the ADA device 202, such as the network interface 114 of the computer system 102 of FIG. 1, operatively couples and communicates between the ADA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ADA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and ADA devices that efficiently implement the method for training the neural language-based model for the data annotation.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Networks (PSTNs), Ethernet-based Packet Data Networks (PDNs), combinations thereof, and the like.

The ADA device 202 may be a standalone device or integrated with one or more other devices or apparatuses, such as one or more of the server devices 204(1)-204(n), for example. In one particular example, the ADA device 202 may include or be hosted by one of the server devices 204(1)-204(n), and other arrangements are also possible. Moreover, one or more of the devices of the ADA device 202 may be in the same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the ADA device 202 via the communication network(s) 210 according to the Hypertext Transfer Protocol (HTTP)-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store data that relates resolution of production problems, storage planning, schedule planning, datasets related to the prediction of resolution to production problems, machine learning models.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ADA device 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the ADA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ADA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ADA device 202, the server devices 204(1)-204(n), or the client devices 208(1)-208(n), for example, may be configured to operate as virtual instances on the same physical machine. In other words, one or more of the ADA devices 202, the server devices 204(1)-204(n), or the client devices 208(1)-208(n) may operate on the same physical device rather than as separate devices communicating through communication network(s) 210. Additionally, there may be more or fewer ADA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

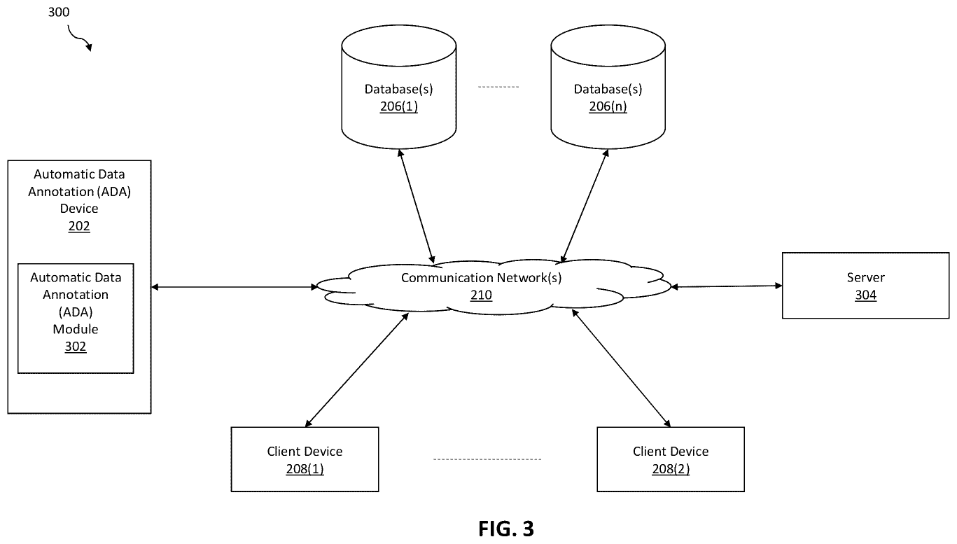

FIG. 3 illustrates a system diagram for implementing a method for training the neural language-based model for the data annotation in accordance with an exemplary embodiment.

As illustrated in FIG. 3, the system 300 may include an ADA device 202 within which an automatic data annotation (ADA) module 302 is embedded, a server 304, a database(s) 206(1) . . . 206(n), a plurality of client devices 208(1) . . . 208(2), and a communication network(s) 210.

According to exemplary embodiments, the system 300 may comprise the ADA device 202 including the ADA module 302 may be connected to the server 304, and the databases(s) 206(1) . . . 206(n) via the communication network(s) 210, but the disclosure is not limited thereto. The ADA device 202 may also be connected to the plurality of client devices 208(1) . . . 208(2) via the communication network(s) 210, but the disclosure is not limited thereto. The database(s) 206(1) . . . 206(n) may include a rule database.

In an embodiment, the ADA device 202 is described and shown in FIG. 3 as including the ADA module 302, although it may include other rules, policies, modules, databases, or applications, for example. As will be described below, the ADA module 302 is configured to implement the method for training the neural language-based model for the data annotation.

An exemplary process 300 for implementing a mechanism for training the neural language-based model for the data annotation by utilizing the network environment of FIG. 2 is shown as being executed in FIG. 3. Specifically, a first client device 208(1) and a second client device 208(2) are illustrated as being in communication with ADA device 202. In this regard, the first client device 208(1) and the second client device 208(2) may be “clients” of the ADA device 202 and are described herein as such. Nevertheless, it is to be known and understood that the first client device 208(1) and/or the second client device 208(2) need not necessarily be “clients” of the ADA device 202, or any entity described in association therewith herein. Any additional or alternative relationship may exist between either or both of the first client device 208(1) and the second client device 208(2) and the ADA device 202, or no relationship may exist.

Further, the ADA device 202 is illustrated as being able to access one or more database(s) 206(1) . . . 206(n). The ADA module 302 may be configured to access these repositories/databases for implementing the method for training the neural language-based model for the data annotation. In some embodiments, the server 304 may be the same or equivalent to the server device 204 as illustrated in FIG. 2.

The first client device 208(1) may be, for example, a smartphone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the ADA device 202 via broadband or cellular communication. Of course, these embodiments are merely exemplary and are not limiting or exhaustive.

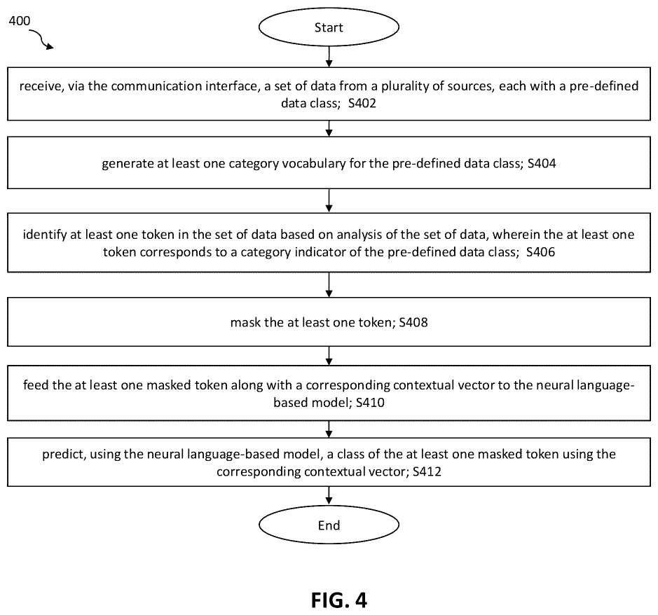

Referring to FIG. 4, an exemplary method 400 is shown for training the neural language-based model for data annotation, in accordance with an exemplary embodiment. As shown in FIG. 4, the method begins following a need for training the neural language-based model for the data annotation.

At step S402, the method includes receiving, by at least one processor 104 via a communication interface 114, a first set of data from a plurality of sources, each respective item of the first set of data being associated with a pre-defined data class. The set of data includes domain-specific data. In an example, the received set of data is associated with at least one domain, such as financial reforms introduced by the government for a financial year. The first set of data is accompanied by the corresponding pre-defined data classes associated with the set of data. In an exemplary embodiment, the plurality of sources includes but may not be limited to repositories, cloud-based servers, third-party platforms, organizations, and the like. In another exemplary embodiment, the set of data may be received in the form of screenshots or snapshots.

At step S404, the method includes generating, by at least one processor 104, at least one category vocabulary for the pre-defined data class. In an example, the pre-trained neural language-based model generates a category vocabulary for each of the pre-defined data classes in the received first set of data. For instance, if four pre-defined classes of data are present in the first set of data, then the neural language-based model generates a respective category vocabulary corresponding to each of the four pre-defined data classes. The category vocabulary includes the words that have contextually similar meanings to the associated pre-defined data class of the category vocabulary. The words present in the category vocabulary are ranked based on the number of times the word in the category vocabulary can replace the associated pre-defined class in the first set of data. In an exemplary embodiment, pre-defined data classes are received from the plurality of sources together with the first set of data. The encoder of the neural language-based model finds a contextual vector that corresponds to each of the pre-defined data classes. The contextual vector is then fed to the neural language-based model to obtain a probability distribution indicating words that have a contextually similar meaning to the associated pre-defined data class. In an example, “Politics” is a received pre-defined data class. The corresponding category vocabulary generated by the neural language-based model may include words like politics, political, politicians, government, elections, democracy, democratic, republic, governing, and the like. In another example, the category vocabulary corresponding to the pre-defined data class of “Smart Phone” may include smartphone, mobile phone, user equipment, user device, cell phone, digital phone, and the like.

At step S406, the method includes identifying, by the at least one processor 104, at least one token in the first set of data based on an analysis of the first set of data, wherein the at least one token corresponds to a category indicator of the pre-defined data class. In an example, the neural language-based model identifies tokens in the first set of data that are category indicative of the pre-defined data class. In an example, the method may use the Term Frequency-Inverse Document Frequency (TF-IDF) technique of vectorization to analyze the first set of data. The technique is used to identify tokens that have a similar contextual vector to that of the pre-determined data class. In an example, the softmax function may be used to convert the contextual vector of the token to a probability distribution.

In an exemplary embodiment, identifying the at least one token in the first set of data includes the steps of identifying, by the at least one processor 104, contextually similar words in the first set of data that represent the pre-defined data class. Next, the method includes retrieving, by the at least one processor 104 from a word repository, at least one replacement word for the contextually similar words. Next, the method includes checking, by the at least one processor 104, an occurrence of the at least one replacement word in the at least one category vocabulary. Thereafter, the method includes tagging, by the at least one processor 104, the contextually similar words as the at least one token in an event the occurrence of the at least one replacement word in the at least one category vocabulary exceeds a threshold number. In an exemplary embodiment, the threshold number may depend on factors such as the number of words contained in the category vocabulary. In an example, the threshold number is set at a pre-defined value of 50. In an example, the occurrence of the replacement words for a word contextually similar to a pre-defined class is checked in the corresponding category vocabulary. In an event that the occurrence of the replacement words in the category exceeds a predetermined threshold, the contextually similar word is identified as a token that is category indicative of the pre-defined data class. The token is then added to the category vocabulary. Thus, the method includes updating, by the at least one processor, the at least one category vocabulary with the identified at least one token for the corresponding pre-defined data class.

At step S408, the method includes masking, by the at least one processor 104, the at least one token. In an example, the category indicative token is masked in a corresponding contextual vector. The neural language-based model understands the context of tokens instead of memorizing the context when masking is applied. The masking of the tokens provides more accuracy and reliability in the prediction of the context and the associated data class by the neural language-based model.

At step S410, the method includes feeding, by the at least one processor 104, the masked at least one token together with a contextual vector to the neural language-based model. In an example, the neural language-based model is provided with the contextual vector of the at least one token, where the token is masked.

At step S412, the method includes predicting, by the at least one processor 104 using the neural language-based model, a class of the masked at least one token using the corresponding contextual vector. In an example, the neural language-based model predicts the class of the masked at least one token using the contextual vector of the token. In an example, for the statement “In all sports, cricket is a very popular sport”, the predetermined data class is “outdoor sports”, and “cricket” is the token. The neural language-based model is trained with a contextual vector of “cricket” with the token “cricket” masked. The neural language-based model may then identify the class “outdoor sports” using the contextual vector of the token (i.e., cricket) with the masked token. In an exemplary embodiment, the Cross-entropy Loss function is used by the neural language-based model along with the contextual vector of the at least one token to identify the associated pre-defined data class.

In an exemplary embodiment, the method further includes implementing a self-training process for the neural language-based model on an unlabeled second set of data. In an example, the neural language-based model creates the contextual vector for the entire corpus of the unlabeled second set of data for the purpose of self-training. The neural language-based model may use the Kullback-Leibler Divergence loss function to enhance the efficacy of the self-training process. The self-training process helps to train the neural language-based model for better generalization, as the entire sequence in the first set of data is used for the self-training.

In an exemplary embodiment, the neural language-based model is pre-trained using NLP techniques. The neural language-based model is trained to generate training data for the machine learning models that may be used for various tasks, such as data annotation.

In another exemplary embodiment, the neural language-based model relies upon a discriminative learning model in an event that the data classes in the first set of data are pre-defined (i.e., the first set of data is highly domain-specific).

In an example, on a social media platform, users post news content from various domains. A person interested in sports is also a user of the social media platform. The person wants to only check the news related to sports out of the plurality of posts available on the social media platform. However, it is difficult for the user to only check sports-related posts without reading other posts. With the help of the features of the present disclosure, the person may get the sports-related posts only by checking the labels of the posts. For instance, the user can quickly check, through the annotation or label, the sports-related posts out of the plurality of posts available on politics, sports, industries, technology, religion, travel, entertainment, and education on the social media platform.

With reference to the example above, the model's training to annotate a plurality of posts begins by creating a category of words or vocabulary for each predefined label. For instance, the sports vocabulary may include terms such as game, cricket, score, tournament, fan, umpire, defeat, victory, match, team, run, and athlete, among others. Next, each word in a post is checked for similarities with the words in the category vocabulary defined for the various domains. In the example, the post reads: “Mr. A scored the highest runs in the match and was therefore awarded the Man of the Match.” Consequently, each word in the sentence is compared with similar or replacement words. Based on the maximum number of words matching a predefined category of domains, the post is tagged with the corresponding domain. Additionally, to facilitate accurate tagging, the method involves masking the words in the sentence to better understand the context of category indicative word within the sentence and to validate its category.

For example, in the given sentence, terms like score, match, runs, and “Man of the Match” also belong to the sports category vocabulary. Thus, the present disclosure identifies the sentence under the sports domain and tags it accordingly. Similarly, the model can be applied to a corpus of data, such as a plurality of posts on the social media platform, to label each post with its corresponding domain.

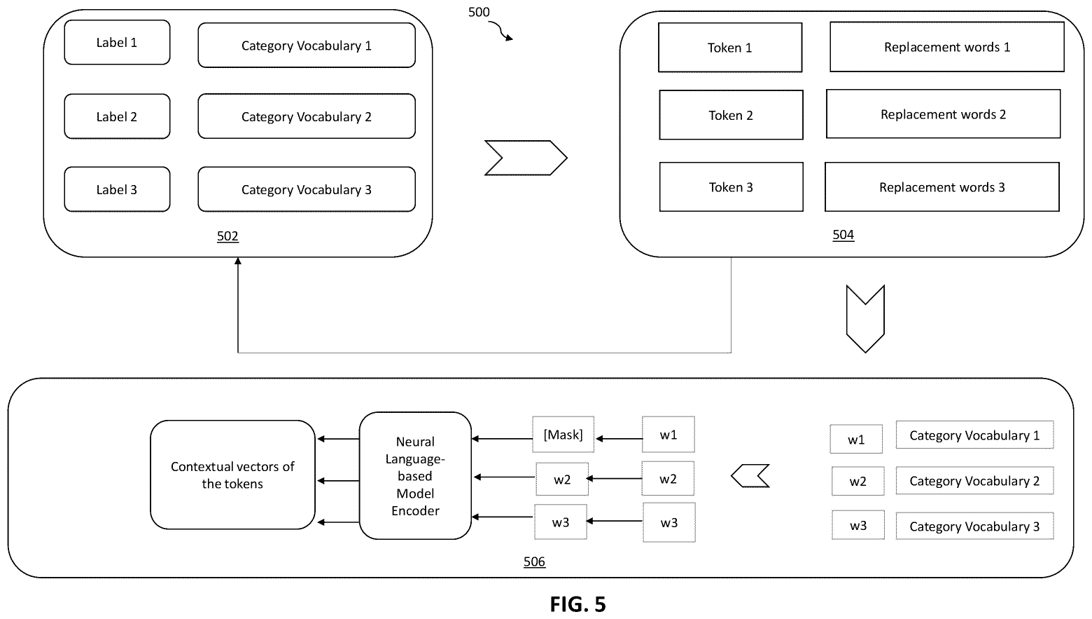

FIG. 5 illustrates a process flow diagram usable for implementing a method for training a neural language-based model for data annotation, in accordance with an exemplary embodiment. As illustrated in FIG. 5, the process flow 500 begins with receiving a first set of data, each with a pre-defined data class. The pre-defined data classes are illustrated in 502 as label 1, label 2, and label 3. The neural language-based model generates a respective category vocabulary for each of the received pre-defined data classes. The category vocabulary 1 corresponds to the label 1, the category vocabulary 2 corresponds to the label 2, and the category vocabulary 3 corresponds to the label 3. Next, the process flow involves identifying tokens in the first set of data with similar contextual meaning as the received pre-determined data class. As illustrated in 504, token 1 corresponds to a token identified by the neural language-based model, where token 1 is contextually similar to indicate label 1. The neural language-based model then identifies replacement word 1 for token 1 and checks if the occurrence of replacement word 1 in the category vocabulary 1 exceeds a predetermined threshold number. In an event, the threshold is crossed, the token 1 is added to the category vocabulary 1. Similarly, token 2 and token 3 illustrated in 504 are checked to get stored in the corresponding category vocabulary as category indicative words.

The process as illustrated in 502 addresses the challenges related to the limited coverage of category vocabulary. The enrichment of category vocabulary is done by adding tokens identified in the first set of data that are found to be category-indicative. Thereafter, the process flow is illustrated in 506. The neural language-based model encoder is successively trained with each token in the corresponding category vocabulary. As illustrated, the identified masked token w1 from its contextual 1 vector is fed to the neural language-based model encoder. A similar process is repeated for all the tokens present in category vocabulary 1. Further, a similar process is used for category vocabulary 2 and category vocabulary 3. The neural language-based model encoder is thereby trained on the contextual vectors of each associated token. The masking of the tokens allows the neural language-based model to better understand the context of the tokens and to validate the token associated with the first set of data. The training of the neural language-based model with the masked tokens enables the neural language-based model to predict the associated class using the contextual vector of the token.

Accordingly, with this technology, the process for training the neural language-based model for the data annotation is disclosed. As is evident from the above disclosure, the present solution provides significant technical advancement over the existing solutions by ensuring minimum reliance placed on human expertise in generating training data for machine learning models. Therefore, as disclosed in the present disclosure, the method and system for training neural language-based model for data annotation helps in reducing dependency on humans, faster generation of training data, better prediction of pre-defined data class present in the set of data, and better handling of the set of data, where the received set of data is highly domain-specific (e.g., the data classes are pre-defined).

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for training a neural language-based model for data annotation is disclosed. The instructions include executable code which, when executed by a processor, may cause the processor to receive, via a communication interface, a first set of data from a plurality of sources, each item of the first set of data being associated with a pre-defined data class; generate at least one category vocabulary for the pre-defined data class; identify at least one token in the first set of data based on an analysis of the first set of data, wherein the at least one token corresponds to a category indicator of the pre-defined data class; mask the at least one token; feed the masked at least one token together with a corresponding contextual vector to the neural language-based model; and predict, using the neural language-based model, a class of the masked at least one token using the corresponding contextual vector.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for training a neural language-based model for data annotation, the method comprising:
receiving, by at least one processor via a communication interface, a first set of data from a plurality of sources, each item of the first set of data being associated with a pre-defined data class;
generating, by the at least one processor, at least one category vocabulary for the pre-defined data class;
identifying, by the at least one processor, at least one token in the first set of data based on an analysis of the first set of data, wherein the at least one token corresponds to a category indicator of the pre-defined data class;
masking, by the at least one processor, the at least one token;
feeding, by the at least one processor, the masked at least one token together with a corresponding contextual vector to the neural language-based model; and
predicting, by the at least one processor using the neural language-based model, a class of the masked at least one token using the corresponding contextual vector.

2. The method as claimed in claim 1, wherein the identifying of the at least one token in the first set of data comprises:
identifying, by the at least one processor, contextually similar words in the first set of data that represent the pre-defined data class;
retrieving, by the at least one processor from a word repository, at least one replacement word for the contextually similar words;
checking, by the at least one processor, an occurrence of the at least one replacement word in the at least one category vocabulary; and
tagging, by the at least one processor, the contextually similar words as the at least one token in an event that the occurrence of the at least one replacement word in the at least one category vocabulary exceeds a threshold number.

3. The method as claimed in claim 1, further comprising implementing a self-training process for the neural language-based model on an unlabeled second set of data.

4. The method as claimed in claim 1, further comprising:
updating, by the at least one processor, the at least one category vocabulary with the identified at least one token for the pre-defined data class.

5. The method as claimed in claim 1, wherein the first set of data comprises domain-specific data.

6. A computing device configured to implement an execution of a method for training a neural language-based model for data annotation, the computing device comprising:
a processor;
a memory; and
a communication interface coupled to each of the processor and the memory,
wherein the processor is configured to:
receive, via the communication interface, a first set of data from a plurality of sources, each item of the first set of data being associated with a pre-defined data class;
generate at least one category vocabulary for the pre-defined data class;
identify at least one token in the first set of data based on an analysis of the first set of data, wherein the at least one token corresponds to a category indicator of the pre-defined data class;
mask the at least one token;
feed the masked at least one token together with a corresponding contextual vector to the neural language-based model; and
predict, using the neural language-based model, a class of the masked at least one token using the corresponding contextual vector.

7. The computing device as claimed in claim 6, wherein to identify the at least one token in the first set of data, the processor is further configured to:
identify contextually similar words in the first set of data that represent the pre-defined data class;
retrieve, from a word repository, at least one replacement word for the contextually similar words;
check an occurrence of the at least one replacement word in the at least one category vocabulary; and
tag the contextually similar words as the at least one token in an event that the occurrence of the at least one replacement word in the at least one category vocabulary exceeds a threshold number.

8. The computing device as claimed in claim 6, wherein the processor is further configured to implement a self-training process for the neural language-based model on an unlabeled second set of data.

9. The computing device as claimed in claim 6, wherein the processor is further configured to update the at least one category vocabulary with the identified at least one token for the pre-defined data class.

10. The computing device as claimed in claim 6, wherein the first set of data comprises domain specific data.

11. A non-transitory computer readable storage medium storing instructions for training a neural language-based model for data annotation, the storage medium comprising executable code which, when executed by a processor, causes the processor to:
receive, via a communication interface, a first set of data from a plurality of sources, each item of the first set of data being associated with a pre-defined data class;
generate at least one category vocabulary for the pre-defined data class;
identify at least one token in the first set of data based on an analysis of the first set of data, wherein the at least one token corresponds to a category indicator of the pre-defined data class;
mask the at least one token;
feed the masked at least one token together with a corresponding contextual vector to the neural language-based model; and
predict, using the neural language-based model, a class of the masked at least one token using the corresponding contextual vector.

12. The storage medium as claimed in claim 11, wherein to identify the at least one token in the first set of data, when executed by the processor, the executable code further causes the processor to:
identify contextually similar words in the first set of data that represent the pre-defined data class;
retrieve, from a word repository, at least one replacement word for the contextually similar words;
check an occurrence of the at least one replacement word in the at least one category vocabulary; and
tag the contextually similar words as the at least one token in an event that the occurrence of the at least one replacement word in the at least one category vocabulary exceeds a threshold number.

13. The storage medium as claimed in claim 11, wherein when executed by the processor, the executable code further causes the processor to implement a self-training process for the neural language-based model on an unlabeled second set of data.

14. The storage medium as claimed in claim 11, wherein when executed by the processor, the executable code further causes the processor to update the at least one category vocabulary with the identified at least one token for the pre-defined data class.

15. The storage medium as claimed in claim 11, wherein the first set of data comprises domain specific data.
